(19) United States
(12) Patent Application Publication
(10) Pub. No.: US 2024/0107982 A1
(43) Pub. Date: Apr. 4, 2024

(54) Dog vest shorts poop collector

(71) Applicant: Pablo L. Cruz, Paterson, NJ (US)

(72) Inventor: Pablo L. Cruz, Paterson, NJ (US)

(21) Appl. No.: 17/958,180

(22) Filed: Sep. 30, 2022

(51) Int. Cl. A01K 13/00; A01K 23/00

(52) U.S. Cl. CPC A01K 13/006; A01K 23/00

(57) ABSTRACT

A device for wearing by a dog that collects the animal's waste so the owner does not have to. It is put on the animal's back and is adjustable around the neck and the hind legs by velcro. The waste collector bag is attached to the device under the animal's tail, also by velcro and 2 snaps to make it more secure. This bag made of surgical fabric, is thrown away by the owner when full, and is safe for the environment. It has fluorescent lines on the edges, the legs, and the back to illuminate the garment at night. When the animal has done its business, and the owner disposes of the bag, there is a sanitary covering that covers the rectum of the dog to prevent the dirtying and staining of car seats or furniture.

### CROSS-REFERENCE TO RELATED APPLICATIONS

The present application is a non-provisional patent application co-related to provisional patent application Ser. No. 63/261,940 filed on Sep. 30, 2021 and this application claims priority over that application and that application is incorporated in its entirety herein by reference.

### STATEMENT REGARDING FEDERALLY SPONSORED RESEARCH OR DEVELOPMENT

Not Applicable

### REFERENCE TO A SEQUENCE LISTING

Not Applicable

### BACKGROUND OF INVENTION

Dogs have become peoples' favorite pets all over the world and considered part of the family. In addition to companionship, they provide assistance to the blind and children or serve as part of the police and military. The collection of fecal matter from these beloved canines represents a challenge for the environment and human health. Many pet owners use plastic bags to collect the waste from their dogs that they then throw away, which has consequences for the planet that our children and grandchildren will inherit. Other dog owners do not collect their dogs' feces that often contain parasites and worms that are a risk to the health of humans and an inconvenience to others who may come across it. The current invention relates to a device for receiving, collecting and storing feces. It does so in a practical and efficient way; by a disposable bag made of surgical fabric so as not to harm the environment. This disposable bag is attached to the vest shorts poop collector positioned under the animal's tail, around the anus, using velcro and snaps without compromising the free movements of the animal's tail. The current invention provides privacy to the pet when defecating. As soon as the dog finishes, the disposal bag is detached from the vest shorts poop collector and thrown away. U.S. Pat. No. 3,875,903A Pet Pampers has a disposable element that is attached to their invention, however it is attached to a solid frame that may be uncomfortable to the pet. The current invention has no solid parts so the animal can move easily and freely. US Pa. No. 20050263105A1 also has an excrement collective device that is completely thrown away and is essentially a diaper. The current invention has a small detachable piece that is thrown away apart from the garment and is stylish and customizable to the owner's liking. U.S. Pat. No. 3,817,217A Is a sanitary receiver and harness device for use on small animals. Domesticated dogs, however, come in all shapes and sizes and should be fitted properly when wearing garments. The present invention allows an owner to measure their pet, whether small or large, to fit the garment comfortably.

### BRIEF SUMMARY OF INVENTION

The present invention relates to the field of devices worn by an animal. Particularly, this invention is worn by dogs used to receive, encapsulate and retain their fecal matter. It consists of a vest-shorts combo made of vinyl leather to keep one's pet warm in colder weather and flax linen for one's pet to be kept cool in warmer weather. The device extends from the back of the neck of the dog to its back legs. It adjusts to the pet's size using an adjustable collar around its neck and straps around its hind legs. It has a disposable bag made of surgical fabric that is attached under the animal's tail through velcro and snaps to receive and capture waste. For late night dog walks, The device has fluorescent lines on the edges, legs, and back so as to be seen at night as shown in FIG. 1.

### BRIEF DESCRIPTION OF DRAWINGS

FIG. 1 illustrates an aerial view of the current art of the poop collector vest and all its components including the collar, the decorative component that attaches to the back of the vest, the fluorescent edges, and the front and back view of the detachable bag.

FIG. 2 illustrates the measurements by size, (small, medium, large, extra large) of the extension of the vest that goes on the back of the dog.

FIG. 3 illustrates the measurement by size of the waste collector.

FIG. 4 illustrates the five steps of placing the poop collector on a dog.

### DETAILED DESCRIPTION OF THE INVENTION

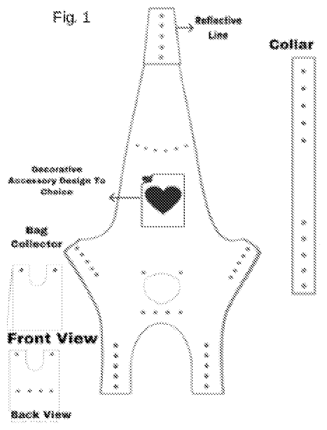

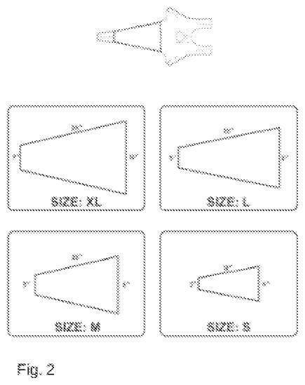

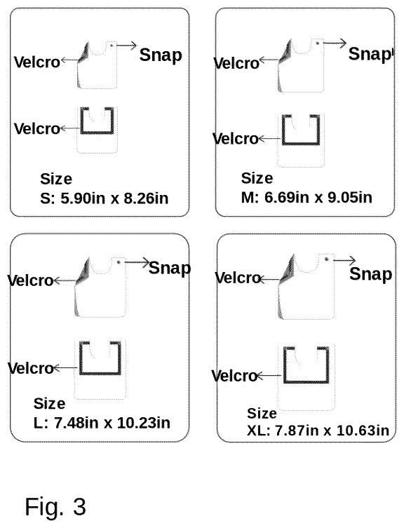

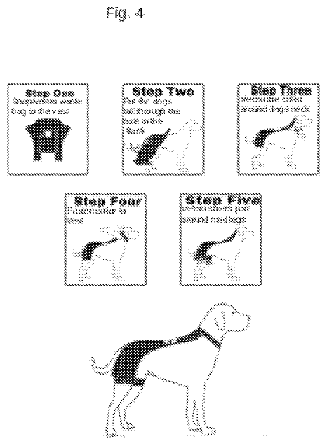

The present invention consists of a vest-shorts combination made of flax or vinyl linen, depending on the weather, that come in a few popular colors like blue, red, green, purple, and pink. To properly find the size that fits one's dog, an individual should measure the length from the dog's neck to its tail. The vest part of the invention covers the back part of the dog in the shape of an isosceles triangle as displayed in FIG. 2. It adjusts to the body by fastening it at the collar displayed in FIG. 4 step 3. The shorts part also velcros around the dog's back legs, displayed in FIG. 4 step 5. The shorts part has an opening at the back like an oval that the dog's tail goes through (FIG. 5 step 2). There is also velcro and 2 snaps where the disposable bag, made of surgical fabric, is attached. The bag fits under the dog's tail and under the rectum to collect the animal's feces as shown in FIG. 3. When full, the bag is removed and the oval orifice on the shorts will be covered by a hygienic covering the same size as the bag. This ensures the car seats or furniture don't get stained or dirty after the dog is finished pooping. There is a piece of velcro in the middle of the vest area that could be used to attach a design of the owner's choice, like the pet's name or a photo (FIG. 1).

1. A device for wearing by a dog for the sanitary disposal of solid waste characterized by:
A safe-for-the-environment disposable bag attached under the pets rectum made of surgical fabric and
A garment that extends from the back of the pets neck to the underside if the tail and
Velcro straps attached to the garment for fastening to the pet at the neck, and hind legs.

2. A device, as recited in claim 1, wherein the material of the vest-shorts combo comprises of:
Vinyl leather or
Flax linen material.

3. A device, for wearing by a dog where the disposable waste bag is:
detachable from the shorts portion by velcro and 2 snaps.

4. A device, for wearing by a dog, where the vest portion is in the shape of an isosceles triangle.
